(19) United States
(12) Patent Application Publication
(10) Pub. No.: US 2012/0117885 A1
(43) Pub. Date: May 17, 2012

(54) Pedestrian Gate Closer

(76) Inventor: Danny DeGott, Elgin, IL (US)

(21) Appl. No.: 12/876,505

(22) Filed: Nov. 15, 2010

(51) Int. Cl. E05F 1/10

(52) U.S. Cl. 49/386

(57) ABSTRACT

A pedestrian gate closer for a pedestrian gate is provided. The pedestrian gate closer includes a housing mounted to the gate or hinge support structure depending on mounting conditions. A pedestrian gate closer is mounted into the housing. An adjustable arm is fastened to the support post or the gate depending on mounting conditions. The arm is fitted with an adjustable collar which slips over the rotatable output shaft of the pedestrian gate closer so that when the gate is opened the closer rotates adding pressure to the closing spring. When the force is removed from the gate the closer closes the gate safely and securely.

### REFERENCE CITED

U.S. Patent Documents

| | | |
|---|---|---|
| 1,989,908 | February 1935 | Bohnsack |
| 2,550,756 | May 1951 | Bartoszek |
| 2,866,224 | December 1958 | Ellis |
| 3,373,529 | March 1968 | Ingham |
| 4,831,687 | May 1989 | Lin et al. |
| 5,732,508 | March 1998 | Latta/Mowery |

### BACKGROUND OF THE INVENTION

1. Field of the Invention

The present invention relates in general to a pedestrian gate closer and, in particular, to an improved pedestrian gate closer.

2. Description of Relevant Art

Many types of devices have been used to automatically close a gate. For example, many typical outdoor gates use a torsion spring or an extension spring which has one end fastened to the gate and the other end fastened to the gate hinge post so that the spring can close the gate. Thus when the gate is opened the spring is either twisted or stretched and energy is stored in the spring. When the force on the gate is released the spring pulls the gate back to its original closed position. Disadvantageously, this method of using a spring frequently requires a significant amount of force to open the gate. In addition for the spring to ensure that the gate closes fully to latch it results in the need for the gate to slam shut which can be hazardous to persons walking through the entrance and damaging to the latching device.

Other types of gate closers are also know. These gate closers generally have a spring in combination with hydraulic controlled chambers that control an extending arm or articulating arm. These exposed extending arms or articulating arms often create a safety hazard and because they protrude outwardly from the gate objects such as a persons fingers may be caught in the moving parts. They also are easily susceptible to damage by vandalism.

Prior gate closer that uses an existing known hydraulic overhead concealed door closer is also know. For example U.S. Pat. No. 5,732,508 issued to Latta/Mowery discusses using an existing known hydraulic overhead concealed door closer and mounting it in a first housing mounted to a support post, where as the hydraulic closer is inserted through one end of the housing, the closer which has a rotatable shaft which extends through a cut out at the bottom of the housing. The second housing mounts to the gate to which the concealed overhead door closer arm is inserted. The second housing has a cut out at one end which exposes an end of the arm. A door closer arm is used to receive and hold the end of the rotatable shaft. The first and second housing are aligned such in a longitudinal axis. The disadvantages of this closer are that the first housing must be mounted to a support post and the second housing must be mounted to the gate top rail they both must be aligned on an exact longitudinal axis and be level, This requires considerable side room of approx 11″ for the closer housing to mount along side the gate, and the adjustment for misalignment is very small less than four degrees. Also this method of inserting the concealed overhead door closer into the end of the first housing does not allow for adjusting the closing speed adjustments or latching force without first removing the gate and then removing the door closer from the housing. Disadvantageously a concealed overhead door closer has the closing speed and latching force adjustments on the bottom of the hydraulic closer and no closing force adjustment. also disadvantageously the method of inserting the concealed overhead door closer arm into a second housing is that that when installing the first housing and the second housing the installation must be almost perfectly aligned along the longitudinal axis, for there is only a 4 degree adjustment to compensate for misalignment and because the existing known door closer has a relatively short output shaft, the height setting of the closer housing to the gate is critical and must be perfect or the arm will not capture the output shaft properly. Once the arm is fastened into the second housing there is no way to adjust the gate in a longitudinal direction. These conditions make it difficult to make the initial installation and even more difficult to make any future adjustments that may become necessary due to mounting and latching post movement caused by ground settlement, damage or other cause.

There is a need for a true pedestrian gate closer that does not have the above described disadvantages,

A true Pedestrian gate closer is advantageous because they are hidden from view and have no exposed components which protrude from the gate or mounting post and are fully adjustable. A pedestrian gate closer can be mounted to the gate or the support post and can be mounted at either the top or bottom of the gate and either in line or at 90 degrees. As known to one of ordinary skill in the art, a pedestrian gate closer typically contains a combination spring hydraulic mechanism which allows the gate to be opened with a relative small force required. The hydraulically controlled gate closer then slowly closes the gate once the force is removed. The closing speed and force are adjustable to allow for different weights and wind load conditions. The pedestrian gate closer also has an adjustable latching feature that causes more force at the very end of the closing cycle that ensures that the gate is fully closed and latched without slamming the gate.

Many known overhead concealed door closers are available and can be adapted as previously explained; however they do not address the failures as previously described.

It is desirable to construct a pedestrian gate closer which has the advantages of the concealed overhead door closer while not having the above described significant disadvantages of the prior gate closers.

### SUMMARY OF THE INVENTION

In accordance with the one aspect of the present invention, the above described disadvantages of prior door/gate closers are overcome by a new hydraulic pedestrian gate closer which has the closing speed and latching force adjustments on the top of the closer and closing force adjustment on the back end of the closer. Along with a longer output shaft of approximately 1⅛ inch, installed in a housing mounted to the gate or the support post. Where as the housing consists of a lower housing with a removable top. This allows the closing speed and latching force to be adjusted without removing the gate and removing the closer from the housing. It also allows for the full removal and replacement of the closer without the need to remove the gate.

In accordance with another embodiment of the invention, the housing for a pedestrian gate closer is used in conjunction with a fully adjustable arm. This new arm consists of a round collar with a goon nose tab on one side with a square receptacle in the center configured to slip over the pedestrian gate closers output shaft. The round collar with the goon nose tab then slips into the arm assembly which has a corresponding hole with a widened area on one side where the goon nose tab fits. This widened area allows for the arm to be adjusted in a rotational direction. This adjustment allows a 30 degree rotational adjustment off the longitudinal axis. A second embodiment of the arm is the two slotted mounting holes. The slotted mounting holes correspond with a mounting bracket that fastens to the gate. These slotted mounting holes allow the gate to be adjusted along the longitudinal axis. These two adjustments are advantages for the proper operation of the closer; they allow the closer housing to be mounted in many different positions in respect to the gate, the closer housing can be mounted on the gate or on the support post in a straight line along the gates longitudinal axis or up to 15 degrees off straight line, in either direction. The closer housing can also be mounted in a position that varies from 75 degrees to 105 degrees off the gates longitudinal axis, and mounted either on top of gate or below gate. The use of the collar along with the longer output shaft of the pedestrian gate closer allows for a less critical height setting of the closer housing and also allows for an out of level condition. These features allow for both longitudinal and rotational adjustments for proper alignment of the gate to insure the gate closes smoothly and latches securely, both during the initial installation and for necessary future requirements.

### BRIEF DESCRIPTION OR THE DRAWINGS

FIG. 1 is a perspective side view of a pedestrian gate closer in accordance with the preferred embodiment of the present invention as attached to a closed gate.

FIG. 2 is an exploded perspective of a pedestrian gate closer in accordance with the preferred embodiment of the present view.

FIG. 3 is exploded perspective of a section of the pedestrian gate closer arm showing the collar and corresponding receptacle hole in the arm.

### DETAILED DESCRIPTION OF THE PREFERRED EMBODIMENTS

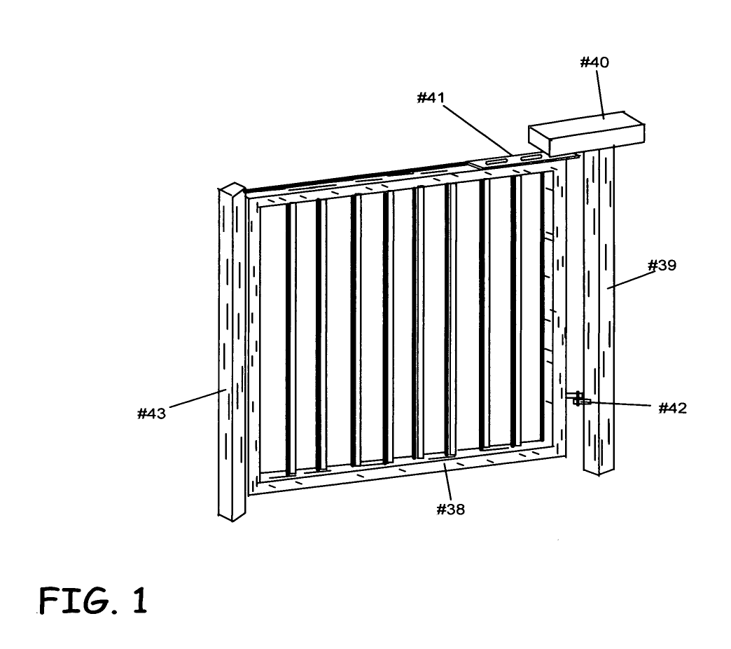

As shown in FIG. 1 a pedestrian gate closer 40 is configured in accordance with the preferred embodiment of the present invention. The pedestrian gate closer 40 is preferably used to close a pedestrian gate 38.

As illustrated in FIG. 1 the pedestrian gate closer housing 40 is attached to the top of the gate 38 or the support structure 39. The bottom gate hinge 42 is also attached to the support structure 39 on one end and attached to the gate 38 on the other end. The adjustable arm 41 is attached to the top of the gate 38. This allows the gate 38 to swing open allowing egress and ingress through the opening.

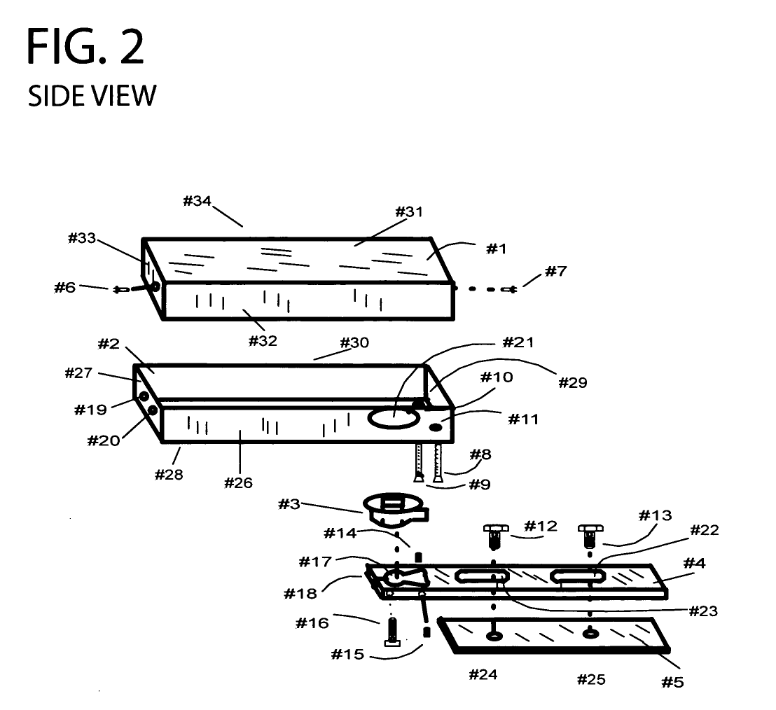

As shown in FIG. 2 the pedestrian gate closer housing #2 to accommodate the pedestrian gate closer 45 consisting of a bottom surface 28 (not shown), left side 26, right side 30 (not shown), front end 27 and back end 29, with the top open. The second part of the housing is the top consisting of a top 31, right side 34 (not shown), left side 32, front end 33 and a rear end 35 (not shown).

As shown in FIG. 2, the bottom surface has an aperture 21 configured to allow the rotatable output shaft 46 of the closer 45 to extend through the housing. The hydraulic closer 45 is then installed from the top and is securely fastened using two bolts 8 and 9 inserted through holes 10 and 11.

Securely fastened to the top surface of the support post 39 is the anchor plate 5, which consists of a solid plate of sufficient thickness with two threaded holes 24 and 25.

The primary gate arm 4 is fastened to the gate plate 5 through the slotted holes 22 and 23 using bolts 12 and 13 threading into the gate plate holes 24 and 25. The collar 3 is inserted into the arm aligning the goon nose tab 27 with the corresponding hole in the arm 17, the square aperture 26 in the collar 3 slips over the pedestrian gate closers output shaft 46.

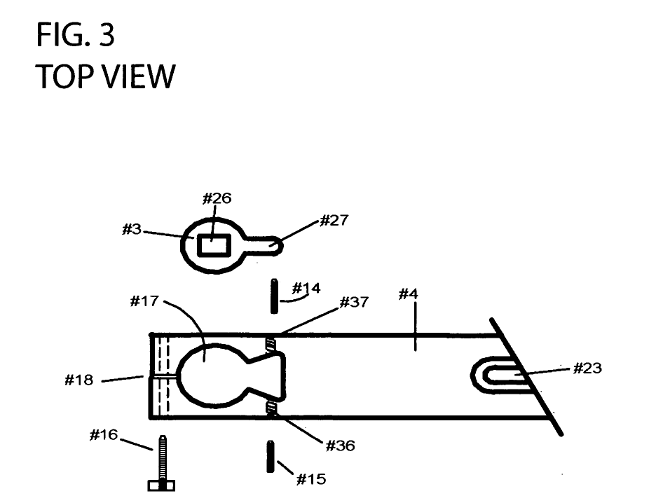

FIG. 3 shows a larger overhead view of the collar 3 and arm's corresponding receiving hole 17, set screws 14 and 15 are inserted in the left and right side adjustment holes 36 and 37 and slotted holes 23 for longitudinal adjustments. the gates fully closed position can be adjusted by inserting the set screw 14 or 15 on the closed side either of the arm 4 until it contacts the collars goon nose tab 27, then the clamp bolt 16 is tightened, due to the gap 18 in the back of the arm 4 this compresses the receiving hole 17 against the collar 3, then the second set screw 14 or 15 is inserted into the open side of the arm 4 and tightened until it contacts the other side of the collars goon nose tab 27 this second set screw locks the collar 3 position adjustment. After all final adjustments have be accomplished arm cover 44 is slipped over arm 4 to cover all bolt and adjustment screws. Future adjustments can be made by removing arm cover 44, loosing the clamp collar 18 and tightening and loosening of the set screws 14 and 15. Once desired adjustments have been accomplished, tighten clamp bolt 16 and reinstall arm cover 44.

In operation the collar 3, adjustable arm 4 and gate plate 5 rotate according to the movement of the gate 38. Due to the output shaft 46 of the pedestrian gate closer 45 being held within the collar 3 which is locked in the arm aperture 17 the movement of the gate 38 causes the output shaft 46 to rotate. When the force against the gate is removed, the pedestrian gate closer rotates the output shaft 46 back to its original position thus causing the gate to close. Although this invention has been described in terms of certain preferred embodiments, other embodiments apparent to those of ordinary skill in the art are also within the scope of this invention.

1. The design of pedestrian gate closer is an all cast iron design and has all of valve adjustments strategically located on the hydraulic body for ease of accurately adjusting the closing speed and latch force without removing the unit from its mounting brackets.
